(19) United States
(12) Patent Application Publication
(10) Pub. No.: US 2022/0036676 A1
(43) Pub. Date: Feb. 3, 2022

(54) METHOD OF CONTROLLING A STORAGE APPARATUS AND STORAGE APPARATUS

(71) Applicant: ILLINOIS TOOL WORKS INC., Glenview, IL (US)

(72) Inventors: Kevin CARTWRIGHT, Halesowen (GB); Lee RASBERRY, Kings Lynn (GB); Chris PLAYFORD, Kings Lynn (GB)

(21) Appl. No.: 17/384,179

(22) Filed: Jul. 23, 2021

(30) Foreign Application Priority Data
Jul. 28, 2020 (GB) 2011680.2

(51) Int. Cl. G07C 9/00; G05B 19/042; G05D 23/19

(52) U.S. Cl. CPC G07C 9/00912; G07C 9/00571; G05B 2219/25111; G05D 23/1917; G05B 19/042

(57) ABSTRACT

Storage apparatus having a plurality of lockable storage compartments, wherein at least some of the storage compartments are temperature controlled. Storage compartment temperature information, SCTI, indicative of a locker temperature category of each storage compartment is obtained. Order information associated with an order of a plurality of items for storage is received, including desired temperature information, DTI, associated with the items, and temperature tolerance information, TTI, associated with the items. The TTI indicates a thermal resilience of the items. In dependence on the SCTI and the DTI, a capacity of the plurality of lockable storage compartments for receipt of the order is identified, corresponding to the DTI for the associated items. A subset of the plurality of lockable storage compartments is determined for storage of the items, in dependence on the identified capacity, DTI and TTI. The subset of lockable storage compartments is unlocked responsive to arrival of the order.

### TECHNICAL FIELD

The present invention relates to a storage apparatus, particularly a locker system, particularly although not exclusively, to a multi-user locker system for the storage of goods.

### BACKGROUND

Locker systems are used for storage of items, such as goods, awaiting collection by a user. Refrigerated locker systems, where lockers are cooled to one or more predetermined temperatures, have been used in a wide range of applications. For example, WO2015114331 (to Illinois Tool Works Inc.) which teaches a temperature controlled lockable storage apparatus wherein the temperature of compartments within a locker is independently controllable to provide either a chilled or frozen temperature. Access to the lockable storage spaces is governed by an access control module which communicates with a central control system at a delivery centre such as a supermarket via a communication module and grants access to the lockable storage spaces for authorised users.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 shows a schematic view of a locker bank illustrating two users contemporaneously collecting delivered items;

FIG. 2 shows a schematic perspective view of a locker bank;

FIG. 3 shows a schematic view of a storage space within a locker bank;

FIG. 4 shows a block diagram showing the communication between the central control system, access control system, and the storage installation.

FIG. 5 shows a schematic view of a locker bank comprising personal communications devices as guidance means;

FIG. 6 shows a schematic view of a Delivery Driver App; a mobile app primarily for couriers;

FIG. 7 shows a schematic view of a Consumer App; a mobile app primarily for consumers;

FIG. 8 illustrates a method for allocating a subset of storage spaces to an order;

FIGS. 9A and 9B illustrate example order information associated with an order placed by a user; and

FIG. 10 illustrates a method for determining the subset of storage spaces.

### DETAILED DESCRIPTION

A distribution network is a group of connected storage facilities and transportation systems that receive goods and then deliver them to consumers.

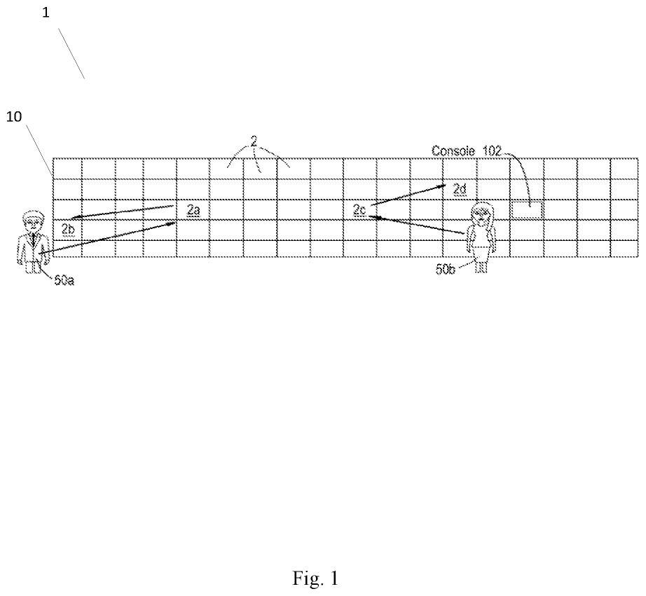

FIG. 1 illustrates a distribution network comprising a storage installation 1. The storage installation 1 at a given collection site may comprise a plurality of lockable storage spaces 2, arranged either in a single locker bank 10 on a given footprint at the collection site, or in two or more separate locker banks 10 typically grouped close to one another on a given footprint at the collection site. At least one user 50 is guided to their allocated lockable storage space(s) 2, more specifically a subset of a plurality of lockable storage spaces 2.

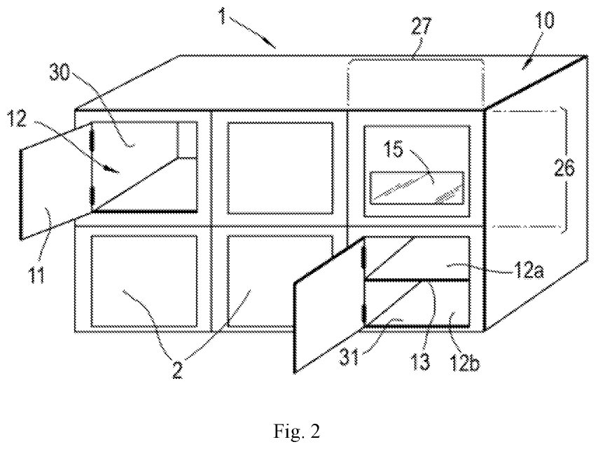

FIG. 2 illustrates a single locker bank 10. Each storage space 2 comprises at least one compartment 12. Additional compartments 12 can be created within a storage space 2 using at least one horizontal, vertical and/or diagonal divider 13 to separate the compartments. The compartments 12 within a storage space 2 may be equal or different in volume and/or shape. Typically, the storage spaces 2 are lockers, i.e. each having a respective lockable door 11; but may also comprise drawers as some items, such as round items, may roll out when a door 11 is opened. The door 11 is typically mounted to the locker bank 10 by a hinge or pivot 21, though any other suitable mounting arrangements, e.g. sliding doors or doors with compound articulations, may also be used; throughout or in any suitable combination. The storage spaces 2 need not comprise a conventional door 11, but instead may have an inner member and an outer member which are moveable or slidable with respect to one another about or along a common axis. Storage spaces 2 may be equal to each other in size and/or volume, or may be different to each other in size and/or volume. Typically, the storage spaces 2 are generally box shaped (rectangular/square parallelepiped-like volumes).

In the case of more conventional generally box-shaped storage spaces 2, these may be joined together side by side in the or each locker bank 10, and usually share side walls 30. The plurality of lockable storage spaces 2 may be positioned such that they are adjacent to one another. For example, a storage installation 1 may comprise one locker bank 10, wherein a locker bank 10 comprises a plurality of storage spaces 2.

Alternatively, a storage installation 1 comprises two or more locker banks 10 wherein each locker bank 10 is placed proximate to another.

FIG. 2 illustrates a locker bank 10 with six storage spaces 2; however, a locker bank 10 can be arranged in a multitude of ways. Preferably, a locker bank 10 has two or more storage spaces 2 wherein the two or more storage spaces 2 are arranged in at least one row 26 and/or at least one column 27 in locker bank.

One or more of the storage spaces 2 in the subset allocated to said at least one user may store goods requiring a particular storage condition, such as a temperature. The user 50 may be a consumer or a courier (delivery person). A consumer may collect goods from a plurality of lockable storage spaces 2 allocated to them. A courier may deliver goods to a plurality of lockable storage spaces 2 allocated to them. Optionally, a consumer may deliver goods to a plurality of lockable storage spaces 2, i.e. in the case of returning the goods. Optionally, a courier may collect goods from a plurality of lockable storage spaces 2 which are returned or uncollected by the consumer.

In embodiments of the present invention, the one or more of the lockable storage spaces 2 store goods which require different storage conditions, in particular different temperatures. The different temperatures may include a frozen temperature, chilled temperature and controlled ambient conditions.

The chilled temperature represents the temperature range for storage of groceries such as milk and yogurt, etc. and covers a range between substantially 0 degrees Celsius to substantially 4° C. The frozen temperature represents the temperature range for storage of frozen groceries such as ice cream and frozen food. For the purpose of the present invention, the frozen temperature covers a range between substantially −25° C. to substantially 0° C., more preferably between substantially −21° C. to substantially −18° C. Preferably, the temperature of each of the one or more compartments is independently controllable to provide any one of ambient or chilled or frozen temperature. The ambient temperature represents the temperature range for storage of typical groceries such as chocolate or dry goods. For the purpose of the present invention, ambient temperature covers a range between substantially 4° C. to substantially 21° C. For the purpose of this invention and all the prior applications, the term “ambient temperature” is construed to mean “room temperature” or more appropriately “controlled ambient temperature”. It does not refer to the actual air temperature of the surrounding environment, for example the sub-zero temperature experienced during the winter months; rather “ambient temperature” means a temperature range suitable for storing goods that do not require refrigerated storage to remain in saleable condition.

Each compartment 12, 12a, 12b of the storage space 2 may comprise at least one variable which is independently controllable, wherein the variable may be temperature, humidity, other atmospheric composition and/or pressure, for example. A subset of the compartments 12, 12a, 12b within a storage installation 1 can for example be in controlled to provide a selectable specified condition whilst another subset of the compartments 12, 12a, 12b within the same storage installation 1 can for example be controlled to provide another selectable specified condition, wherein the selectable specified condition comprises temperature, humidity, other atmospheric condition or composition, pressure etc. Therefore, a user 50 having ordered a variety of goods requiring different storage conditions, e.g. frozen goods and chilled goods, may need to go to two or more separate storage spaces 2 within the storage installation 1 to collect their goods as they will not necessarily be stored together within the same storage space 12. A subset within a storage installation 1 may comprise storage spaces 2 from separate locker banks 10.

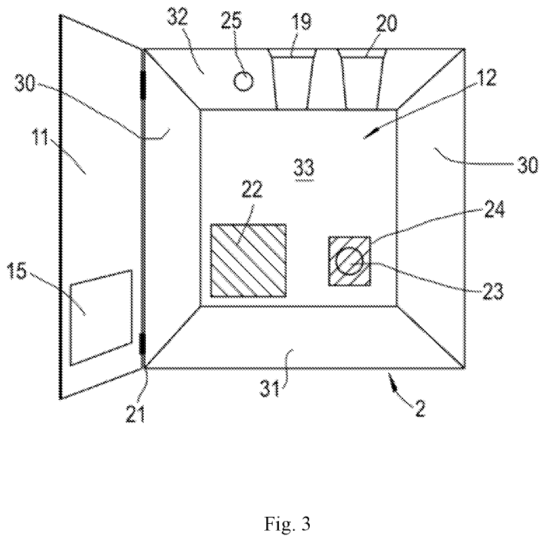

FIG. 3 illustrates a compartment 12 which may comprise a side wall 30, a lower wall 31, an upper wall 32 and a rear wall 33. In order to prevent items contained within a compartment 12 of storage space 2 from rolling or falling out of the compartment 12 upon opening the door 11 to the storage space 2, the lower wall 31 of at least one storage space may be tilted such that it is declined between the edge nearest the door 11 towards the rear wall 33. The angle of decline is preferably between 0 and 10 degrees from the horizontal plane, more preferably between 0 and 5 degrees from the horizontal plane. Alternatively or additionally a horizontally configured divider 13 which is placed in the storage space 2 to create two compartments 12a, 12b (see FIG. 2) may also be declined as described above, to prevent items from falling or rolling out of the upper compartment 12a created by the divider 13. Additionally or alternatively the lower wall 31 and/or the horizontal divider may comprise a lip or threshold adjacent the opening, for a similar purpose.

FIG. 3 shows an internal view of a storage space 2 with one compartment 12. In this exemplary embodiment, the compartment comprises an air conditioner or dehumidifier 22 for dehumidifying the compartment 12. The storage space 2 may comprise an inlet/outlet 23 for a vacuum pump in order to allow control of the pressure within the storage space 2. The compartment 12 may comprise interior illumination such as from a light source 20 facilitating collection and inspection of stored items. The light source 20 may be switched on when the door 11 opened or unlocked, and the light source 20 may be switched off when the door 11 is closed or locked. Optionally, the light source 20 may be switched on or off regardless of the state of the door 11 or lock. In case of a fire within at least one compartment 12, the compartment 12 may be equipped with an active fire protection system 19 such as a fire sprinkler system.

The door 11 may comprise a window 15 such that light can be transmitted from the surroundings to within the at least one compartment 12 of the storage space 2. This can be useful if the item(s) in the compartment 12 require light, e.g. plants. The window may be transparent or translucent. The window 26 may be a smart window such that it can dim or undim by using electrochromic glass which can change from light to dark (i.e. transparent/translucent to more or completely opaque), and back again. The change from light to dark of the electrochromic glass may occur on locking or unlocking the door 11 of the storage space 2, or vice versa. In case the goods stored in the compartment 12 comprises a plant, a plant watering system can be fitted into the compartment 12 such that the plant is watered at set intervals or watering can be controlled manually, controlled remotely or programmed.

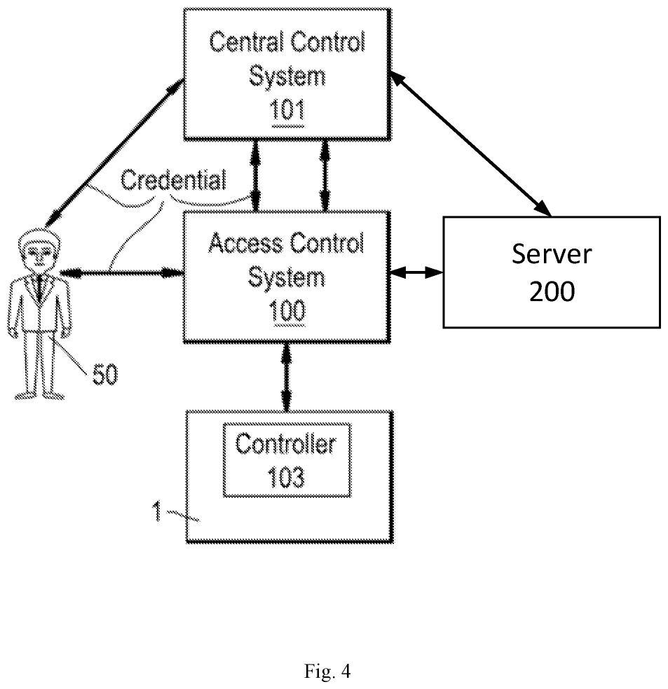

FIG. 4 illustrates a schematic control system for the distribution network.

A central control system 101 within the distribution network may allocate the lockable storage spaces 2 for goods which have been ordered, e.g. online, by a user 50. Based on status information of the lockable storage spaces 2, the central control system 101 may allocate at least one suitable vacant or available storage space 2 for goods deliveries or consignments. The user 50 is allocated one or more storage spaces 2 depending on the condition-requirements of the goods ordered for delivery to a collection point, e.g. chilled, frozen and/or controlled ambient. The central control system 101 may be coupled to an access control system 100, as will be described.

An order can be placed by a user 50 such that the goods ordered will be delivered to at least one of the lockable storage spaces 2, i.e. a subset of the plurality of lockable storage spaces 2, located at a collection site. Once a user 50 has successfully placed an order, the allocation of the subset of a plurality of lockable storage spaces 2 allocated to said user 50 will be stored in a database along with, but not limited to, the user's identity and a list of the ordered goods. The database may be stored on a data storage device wherein the data storage device may be located in the central control system 101. The data storage device may comprise cloud storage 240 or be located in a supermarket or at a delivery centre, or locally within the storage installation 1. The database is coupled to the access control system 100 by way of the central control system.

The lockable door 11 of each storage space 2 is actuated by the access control system 100 to permit a user 50 to gain access to at least one of a subset of the plurality of lockable storage spaces 2. The access control system 100 comprises an access control processor. The access control processor can be any processing device known in the art. Typical examples include but are not limited to a microprocessor. The processor can be communicatively coupled to computer readable media such as a memory device. Different access control systems 100 commonly known in the art are permissible in the present invention. Commonly known access control systems are through the use of barcodes or machine readable media.

A guidance means is configured to guide the user 50 to the allocated storage space 2 once the user 50 has been granted access to their respective subset of allocated storage spaces 2 by the access control system 100. The guidance means is configured to contemporaneously or concurrently guide two or more users to at least part of their respective subset of lockable storage spaces 2. In some embodiments, the access control system 100 may comprise the guidance means, and the guidance means may be operable by the access control processor. In some embodiments, the guidance means may be a guidance device of a user as will be explained.

In one example as shown in FIG. 1, a first user 50a is allocated storage spaces 2a and 2b and a second user 50b is allocated storage spaces 2c and 2d. The guidance means of the present invention can guide the first user 50a to storage space 2a in a variety of ways, examples of which are detailed below. Once the user 50a has collected their ordered goods from the storage space 2a, the guidance means will then direct the user 50a to their second allocated storage space 2b. Alternatively, the guidance means may provide the user 50a with an indication of a location sequence of the subset of lockable storage spaces 2a and 2b at the same time, i.e. upon user registration at the locker bank 10. For at least some of the time during which the first user 50a is being guided for collection of their ordered goods from their allocated storage spaces 2a, 2b, the disclosed storage space access control arrangements permit the second user 50b (and possibly still further users, not shown) to be guided for collection of their goods from their allocated storage spaces (2c, 2d in the case of second user 50b) too.

In order to collect the ordered goods from the subset of a plurality of lockable storage space(s) 2, the user 50 must first confirm that they are in fact the same user 50 that made the order or have been authorised by said user 50 to collect the goods. The access control system 100 grants access to the subset of the lockable storage space 2 allocated to a user 50 provided that it identifies a user based on a credential, and this user identity via the credential matches the user identity stored in the database. This is also referred to as user registration.

The credential may include any one of, but is not limited to, a machine-readable medium such as a barcode or a passcode, a contact payment card, a contactless payment card, a contact smart card, a contactless smart card, an identity document such as a passport or a driver's license, a biometric input or a personal communications device such as a smartphone or a tablet. The biometric input may include, but is not limited to, at least one of a fingerprint, face recognition, hand geometry, iris recognition, retina, palm veins, DNA, palm print, and odour/scent. Geolocation can be used to determine that a credential is in a given place (e.g. in the vicinity of a bank of storage spaces) and can therefore be used to verify a credential, such that, upon user arrival at the collection site, the access control system 100 grants access to the subset of lockable storage spaces 2. The credential may be presented by the user 50 to the access control system 100. In some cases, where the access control system 100 is located in the storage installation 1, the access control system 100 may comprise at least one access control console 102 as illustrated in FIG. 1. The at least one console 102 may comprise a user interaction means and/or means to read/input the credential, e.g. a fingerprint reader, retina recognition or low power wireless communication protocols, e.g. Bluetooth®, Zigbee® etc. The user interaction means may comprise at least one of a display screen and/or a loudspeaker and/or input device and/or graphical user interface and/or a microphone. In the case that the console comprises a display screen, the display screen may be arranged in a portrait or a landscape orientation. The user 50 may register by presenting their credential at the at least one console 102. The access control system 100 compares the credential data with the information stored in the database; if there is a match, access to a subset of the plurality of lockable storage spaces 2 will be granted to the user 50, otherwise access will be denied. The advantage of this is that by having more than one console 102 per locker bank 10, two or more users can contemporaneously register to be granted access to their respective subsets of lockable storage spaces 2.

Once the user 50 is granted access to their respective subset, at least one of the guidance means may be engaged to guide the user 50 to each storage space 2.

The access control system 100 is coupled to a controller 103 located in the storage installation 1 which can control the lock status of each storage space 2.

The first storage space 2 allocated to said user is unlocked or opened and the user 50 retrieves their goods from the first storage space. Acknowledgement that the goods have been retrieved from the first storage space storage space 2 can be determined by the user closing the door or the storage space senses that goods have been removed from the storage space, e.g. senses a change in weight (load cell), interruption in light, motion sensor etc. Upon closing the first storage space 2, the controller 103 may lock the first storage space 2, and the guidance means will communicate to the user 50 the location of the subsequent storage space 2 in their subset.

The access control system 100 may communicate to at least one personal communications device 230 of a user 50. The at least one personal communications device may be utilised for user registration, or as a guidance means, or both, as will be explained.

Examples of a personal communications device 230 are a cellular phone, tablet, smart phone, smart watch, laptop etc. The communication between the access control system 100 to the user's personal communications device 230 may be wireless means such as email, Bluetooth®, WiFi, Zigbee, induction wireless, ultra Wideband (UWB), infrared wireless, near-field communication (NFC) and/or radio-frequency identification (RFID) etc. The user 50 may present a credential via their personal communications device 230, and if it matches the identity of a user 50 stored in the database that was allocated a subset of a plurality of lockable storage spaces 2, may be granted access to their respective subset of lockable storage spaces 2. Therefore, a user 50 can be granted access to their respective subset of a plurality of lockable storage spaces 2.

The distribution network comprises a server 200. The server 200 may be located in or proximate to the storage installation 1, or may be remote from the storage installation 1. An application may be stored in the server 200, and this application may communicate with a mobile app on the user's personal communications device 230. A user may set up an account with a retailer and provide details of preferred collection sites which could be close to home or work as well as providing personal details such as name, address, payment details, e.g. bank or Paypal®. The personal details of the user are stored in a database which could be located in the server 200 of the distribution network and is managed by the central control system 101. The central control system 101 may also link to a delivery system which manages delivery of goods to a user's preferred collection sites according to their preferences in their account. A user having an account with the central control system 101 can log onto a website associated with the central control system. The website has a link to at least one retailer and/or delivery system associated with the central control system. Access to the website can be through the user's personal communications device, e.g. via a mobile app.

The application in the server 200 may communicate with the access control system 100 such that the user 50 can register for access to their respective subset of a plurality of lockable storage spaces, and also be guided by their mobile app on their personal communications device 230.

Therefore, once a user 50 has registered and been granted access by the access control system 100, at least part of the location sequence may be communicated to the user 50 via the mobile app on the personal communications device 230. Alternatively, the application in the server 200 delivers at least part of the location sequence to the user's personal communication device 230 by email or SMS, or other means, other than via the mobile app. Alternatively, the personal communications device 230 is only used for user registration, and the user 50 is guided to their respective subset of a plurality of lockable storage spaces 2 by at least one other guidance means, as will be described.

Alternatively, the user registration is completed via the at least one console, and the user 50 is guided to their respective subset of lockable storage spaces 2 by their personal communications device 230. In this case, once a user has registered at the console, the console or access control system 100 may communicate to the user's personal communications device 230 the location of the storage space 2, and once the user has retrieved their goods from said storage space 2 (i.e. closed the storage space 2), the console or access control system will again communicate to the user's personal communications device 230 indicating the location of the subsequent storage space. In some cases, the entire location sequence may be communicated to the user by way of the personal communications device 230. The communication may be via at least one wireless, such as Bluetooth, emitter which is located proximate to the storage installation. Alternatively, the communication may be via any wireless means between either the storage installation 1 and the personal communications device 230, or between the server 200 and the personal communications device 230.

The personal communications device 230, having received the location sequence from the access control system 100, may guide the user 50 by any sensory channel of said user 50, or combination of sensory channels of said user 50. For example, the personal communications device may display a visual/graphical guide showing the storage spaces location within the storage installation 1, or display a textual guide which says “4C”, or display an augmented reality view. Optionally, or additionally, the personal communications device may playback an auditory guide, for example, different tones depending on the distance the user is from the allocated storage space 2 (i.e. proximity/directional guidance) or synthesised speech whereby the loudspeaker of the device will provide directional and/or instructional guidance (i.e. “left, then forward, then right” and/or “Your next locker is 4C”). Further optionally, the personal communications device 230 may provide haptic feedback for proximity/directional guidance, for example, the device will vibrate when within a predetermined distance from the allocated storage space 2; and/or guide the user towards the allocated storage space by varying the haptic output depending on proximity to it. Not all of these guidance means by sensory channels need be implemented on a personal communications device; they may optionally be centrally or selectively distributedly displayed or broadcast by suitable display screens and/or loudspeakers and/or any other guidance means disclosed herein and located in or proximate to the storage installation 1.

The access control system 100 may comprise one or more wireless emitters to broadcast guidance instructions to a user's personal communications device 230. The wireless emitter may comprise any common wireless means known in the art such as Bluetooth, Zigbee or wi-fi emitters. The user may pair their personal communications device 230 with the access control system during user registration so as to allow the broadcasts to be announced by their personal communications device 230. This broadcast signal can provide guidance instructions to the user 50 by any sensory channel, as discussed above (e.g. visual/graphical, auditory and/or haptic).

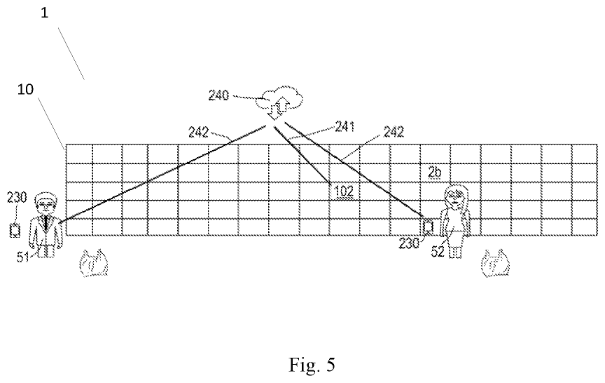

Referring to FIG. 5, when a first user 51 registers with the access control system 100, a processor within the locker bank 10 at the storage installation 1, or even remote from storage installation 1, communicates with the first user's personal communications device 230, which may comprise an application. Alternatively or additionally, the locker bank 10 and/or its storage spaces 2, 2a, 2b may comprise communication means 241 in communication with an access control program e.g. running in the cloud 240. The access control program may be processed by the processor in the server 200 of the distribution network or by a separate processor that is remote of the server 200. The cloud 240 may form part of the central control system. The consumer's personal communications device application and the access control program are “linked” by the customer order number or equivalent identifier (which is assigned to the customer when placing the order, and stored in a database wherein the database is located in the distribution network, e.g. in the central control system 101, e.g. stored in the cloud 240) such that the personal communications device 230 and the cloud 240 are in communication via communication means 242. The access control program may communicate to the user 50, by way of the user's personal communication device 230, at least part of the location sequence of said user's respective subset of lockable storage spaces 2 from the cloud 240 via communication means 242. When the user 51 closes the storage space 2a after having collected their ordered goods from the lockable storage space allocated to them, the processor in the locker bank and/or the access control program communicate (via communication means 241) with the user's personal communications device 230 such that the location of the next storage space is communicated to the user 51 and/or the subsequent storage space in the user 51's allocated subset is unlocked and ready for the ordered goods to be collected by the user 51. A second user 52 with an allocated subset of lockable storage spaces which includes storage space 2b may be guided to such a subset by the same means described above for the first user 51, i.e. the first user 51 and second user 52 are contemporaneously (at least partly simultaneously) guided to their respective subsets of lockable storage spaces 2a, 2b. This is discussed in more detail below. Communication means 241 and 242 may be any of email, wi-fi, SMS etc.

As disclosed above, there are two user registration means via the access control system 100; these are through (i) the at least one console 102 or (ii) the personal communications device of the user 50. The guidance means may include at least one of the at least one console, at least one scanner station, a customer information display system, at least one printer, the personal communications device 230 and any of the other guidance means disclosed herein.

The access control system 100 may comprise at least one printer as a form of guidance means. The at least one printer may operate in conjunction with the at least one console 102. Upon registration by way of the access control system 100, the printer may print a note indicating the location sequence of the subset of lockable storage spaces allocated to a user 50. The note may also include a machine readable medium and/or alphanumeric code which may also act as a credential for access to a respective subset of the lockable storage spaces 2. The at least one printer may be positioned in a locker bank 10, preferably proximate to each console 102. Optionally, the access control system 100 may not comprise a printer but a pre-printed note/receipt is provided together with the goods contained by the first allocated lockable storage space of a user's respective subset. The note may comprise a credential for opening any further allocated storage spaces 2 associated with that order.

The access control system 100 may comprise a customer information display system as a form of guidance means. The customer information display system may comprise at least one customer information display panel. Upon registration, by way of the access control system 100, the customer information display system will indicate the location sequence or subsequent storage space 2 of a respective subset of lockable storage spaces 2 to a user 50 via at least one customer information display panel.

The access control system 100 may comprise at least one scanner station as a form of guidance means, whereby, following user registration and retrieving their goods from their first allocated storage space 2, the user 50 then goes to such a scanner station which will communicate to the user 50 the subsequent storage space of their respective subset when the user 50 presents a credential at the scanner station.

Other guidance means may include one or more of: a storage space number display system in which each storage space 2, comprises a storage space number display screen; a light-based display; an optical head-mounted display and/or other head-mounted device; a path projection system comprising at least one projector; or a loudspeaker system. Any guidance means disclosed herein may be used in combination with any other guidance means also disclosed herein. It will become apparent how this is possible, and why it may be advantageous, through this disclosure.

Upon placing the order or during setting-up of an account with the central control system 101 or during user registration with the access control system, the user can select a preferred type of guidance means. This may be advantageous where the user has a physical disability. For example, a visually impaired user may select to be guided by a loudspeaker system and/or haptic feedback and/or a refreshable braille display input device guidance means.

When employing any of the guidance means, the access control system 100 may facilitate the unlocking/opening of subsequent allocated storage spaces 2 when the preceding allocated storage space 2 has had its contents retrieved by the user 50 and the preceding storage space 2 has been closed. The access control system 100 may unlock a subsequent storage space when its location is communicated to the user 50, and lock said storage space 2 when it is closed. Alternatively, the user may be need to manually open/unlock the storage space that they have been guided to. This may involve a user 50 inputting a code to an input device and/or presenting a credential to a scanner/reader to open/unlock the storage space 2 allocated to said user 50.

Access by the access control system 100 to each lockable storage space 2, or a subset of lockable storage spaces 2 allocated to a user 50, is governed by electronically locking/closing and unlocking/opening the storage space 2, upon verification of user identity based on a credential of said user 50. The electronic locking mechanism can be any mechanism known to the person skilled in the art such as an electromagnetic lock (“maglock”), an electronic strike or electronic deadbolts and latches. The access control system 100 may also monitor the status of each storage space 2 and transfers the status information to a server 200. Status information may include, but is not limited to, at least one of temperature information, dehumidifier information, vacuum information, the light source information, occupancy information, compartment size information, window information, fire sprinkler system information, lock information, and alarm condition information.

The access control system 100 may be coupled to a controller 103 located in the storage installation 1 which can control the lock status of each storage space 2, as shown in FIG. 4.

The sequence by which the allocated storage spaces are arranged in the collection sequence or sequences may be determined by employing at least one algorithm to solve the “shortest path problem” or the “travelling salesman problem”. Additionally or alternatively, the path may be determined by one or more of a heuristics approach; whether goods stored in particular conditions or having particular characteristics should be collected first or last; a user preference; and the location of other users also collecting their goods from their respective subsets of lockable storage spaces 2, in order to prevent overcrowding.

A benefit of the present invention is that the access control system 100, particularly in response to the guidance means, can facilitate two or more users to contemporaneously or at least partially simultaneously collect their ordered goods from their respective subsets of a plurality of lockable storage spaces 2. In one example, a first user 50a is being guided by the guidance means to a first subset of lockable storage spaces 2 allocated to said first user 50a. In the same example, a second user 50b is contemporaneously guided by the guidance means to a second subset of lockable storage spaces 2 allocated to said second user 50b. This is only made possible by the guidance means detailed above; without such means, each subsequent user 50 must wait for the preceding user 50 to complete the collection of their ordered goods from their respective subset of lockable storage spaces 2, and return to the console 102 (which also may not allow simultaneous or contemporaneous user registration by a plurality of users 50).

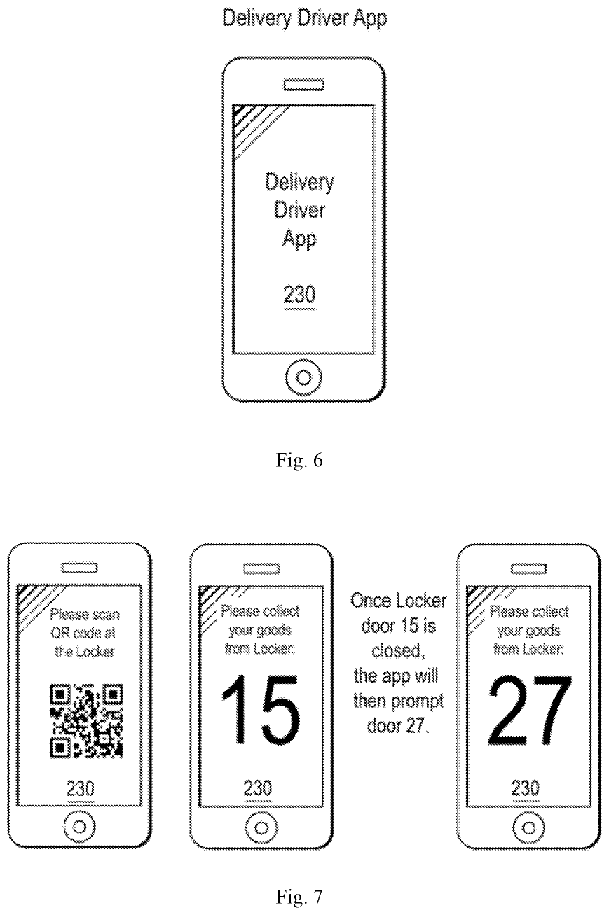

FIG. 6 shows an example of a mobile app for users, in particular the courier or delivery driver, on a personal communications device 230. This mobile app for use by couriers or delivery drivers is referred to as a Delivery Driver App. The Delivery Driver App may register with the access control system (which may be located at the storage installation) by wireless means, such as Bluetooth or Wi-fi. Once the user of the Delivery Driver App is connected to the access control system, the Delivery Driver App may provide a delivery procedure via the personal communications device guiding said user to deliver goods to a subset of lockable storage spaces by at least one guidance means, e.g., but not limited to, any of the guidance means described above.

FIG. 7 shows an example of a mobile app for users, in particular consumers placing and taking delivery of goods orders, on a personal communications device 230. This mobile app for use by consumers is referred to as the Consumer App. The Consumer App may register with the access control system (which may be located at the storage installation) by wireless means, such as Bluetooth or Wi-fi. The Consumer App will navigate the user through the “click and collect” experience. Once a user has registered, such as by scanning a machine-readable medium (FIG. 7a) provided by the Consumer App at an input device, the access control system will consistently “broadcast” both the order number and the next storage space or spaces in the collection sequence. The application will “ignore” the subsequent storage space message if the order number or like identifier does not match that of the user that is using the Consumer App. A user may use a machine-readable medium to open/unlock one of their allocated storage spaces 2. Once the allocated storage space 2 is closed/locked, the Consumer App may then prompt the user to collect their goods from a subsequent allocated storage space by displaying the subsequent allocated storage space on the display screen of the personal communications device as shown in FIGS. 7b & 7c. Optionally, or additionally, the mobile app may prompt the user to collect their goods from a subsequent allocated storage space by utilising an alternative guidance means, as described above.

In embodiments of the invention, the allocation of lockable storage spaces 2 for goods to be stored in the storage apparatus is performed in dependence on status information of the lockable storage spaces 2, and condition requirements of the goods ordered. The condition requirements comprise one or more requirements of desired storage conditions for the goods. The goods may be those which have been ordered by a user 50 or those being returned by a user, for example. The central control system 101 is arranged to determine which lockable storage spaces are vacant or will be vacant at a suitable time. The central control system 101 allocates at least one suitable vacant or available storage space 2 depending on the condition requirements of the order. The condition requirements may comprise a temperature category for each item, e.g. chilled, frozen and/or controlled ambient. The condition requirements may comprise a size of the order, e.g. a number of items and/or dimensional information.

It has been observed that allocation of lockable storage spaces 2 can often be inefficient. The allocation is constrained by the size, configuration and storage conditions of the available lockable storage spaces, and the condition-requirements of the goods ordered for delivery. For example, if the goods ordered comprise items categorised as each of chilled, frozen and ambient, then the order necessitates allocation of three separate storage spaces 2 by the central control system 101 to accommodate the temperature requirement of each item. It is desired to improve the efficiency by which storage spaces are allocated to users, to increase the capacity of orders which may be stored at any given time.

In embodiments of the invention, it has been appreciated that goods may be allocated to storage spaces 2 in an efficient way. Efficiency of allocations may be monitored and adjusted to increase the capacity of the storage installation 1. As such, embodiments of the invention enable more orders may be concurrently stored.

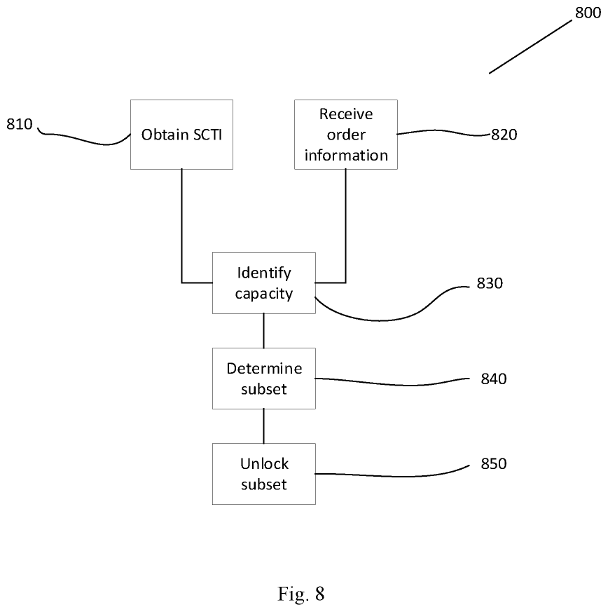

A method 800 for efficient allocation of goods to storage spaces 2 is illustrated in FIG. 8. The method 800 allows reduction in an amount of wasted or unused space by allocating items to the storage spaces 2 based on a temperature tolerance of the items, as will be explained. The method 800 may be performed by the central control system 101 and access control system 100.

The method 800 comprises a step 810 of obtaining storage compartment temperature information, SCTI. The SCTI is indicative of a locker temperature category of each storage compartment 2 in the storage installation 1. As discussed, each compartment 12 of each storage space 2 may comprise independently controllable storage conditions such as temperature, humidity, atmospheric composition and pressure. The condition requirements of the goods may define a temperature category, desired temperature or temperature range at which the goods should be stored. In an illustrative embodiment, the temperature categories may be defined as a chilled category, a frozen category, and a controlled ambient category, as have been explained. However, it will be appreciated that any number and range of temperature categories may be implemented. The temperature of each compartment 12 may be controlled to fall within one of the temperature categories.

Step 810 comprises receiving by the central control system 110 the SCTI. The SCTI may comprise an indication of a locker temperature category at which each compartment 12 is presently configured. For example, the SCTI may comprise an indication of the number of compartments in each of the chilled, frozen and ambient categories. Alternatively, the SCTI may not necessarily directly specify the temperature category, but rather an indication of a temperature or temperature range at which each compartment is configured.

The SCTI may optionally comprise one or more further storage conditions for each compartment 12, such as capacity, pressure, humidity, or atmospheric composition.

The method 800 comprises a step 820 of receiving order information. The order information is associated with an order placed by a user 50. The order information is received by the central control system 110. The order is comprised of one or more items for which storage is requested in the storage installation 1.

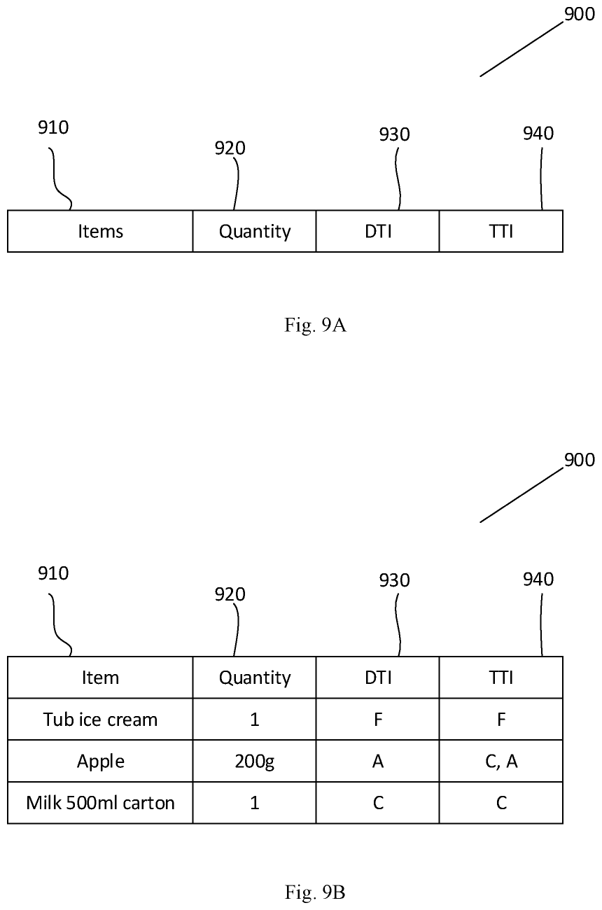

FIG. 9A illustrates order information 900 according to an embodiment of the invention. The order information 900 may comprise an indication of the items 910 associated with the order, a quantity 920 indicative of a storage capacity requirement for the order, desired temperature information 930 associated with the order, and temperature tolerance information 940 associated with the order.

The order information 900 may optionally comprise an indication of the items 910 associated with the order. For example, the indication may be a list 910 or other qualitative description of the items. However, it will be appreciated that according to some embodiments such an item-by-item breakdown is not provided. It will be appreciated that the method 800 may be performed using a storage capacity and a temperature requirement breakdown for the order as a whole by grouping items with similar storage requirements, without requiring a list of each of the associated items.

The order information 910 comprises an indication of a quantity 920 of the order. The quantity 920 may be indicative of a storage capacity requirement for the order, such as a size of compartment 12 or number of compartments 12 required to contain the order. The quantity 920 may optionally be indicated for each individual item. The quantity 920 may comprise an indication of one or more of a number of units of each item, a weight of each item, or a dimension of each item. In some embodiments, the quantity 920 may not be indicated for each individual item, but rather may indicate the overall quantity of items in the order. In particular, the quantity 920 may indicate the storage capacity required at each desired temperature category and each temperature tolerance, as will be explained. For example, the quantity 920 may indicate one small chilled compartment and one large ambient compartment are required.

The order information comprises desired temperature information, DTI 930, associated with one or more of the items. The DTI indicates a desired temperature storage condition for the one or more items. The desired temperature storage condition may comprise a desired locker temperature category. The DTI may indicate the desired locker temperature category to be one of chilled, frozen or ambient. For example, if the order comprises chilled groceries such as milk or yogurt, the DTI may indicate a desired temperature category for these items to be chilled. The DTI may additionally or alternatively define a desired temperature or range of temperatures for the items, for example 4 degrees Celsius or −12 to −15 degrees Celsius. The DTI may indicate the desired temperature storage condition for each item individually, or for a group of items. For example, the DTI may indicate that the order comprises items with a desired temperature category of chilled and ambient without specifying which items fall within each category.

The order information comprises temperature tolerance information, TTI 940, associated with the one or more items. The TTI is indicative of a thermal resilience of the items. That is, the TTI indicates whether the items are resilient to being stored at an alternative temperature to the desired temperature. For example, the TTI 940 may indicate one or more further locker temperature categories to which the item is resilient.

FIG. 9B illustrates order information 900 associated with an example order placed by a user 50 for 1 tub ice cream, 200 g apples, and 1 milk carton. The order information 900 comprises a list 910 of the items and an associated quantity 920 for each item. The order information comprises DTI 930 and TTI 940 associated with each item. The DTI 930 and TTI 940 indicates that the tub of ice cream has a desired temperature category ‘F’, Frozen, and that the tub of ice cream is only resilient to ‘F’, Frozen. That is, the tub of ice cream is not resilient to storage at other temperature categories, in this example due to risk of spoiling the product. The apples, although associated with a desired ambient ‘A’ temperature category, are indicated as resilient to either ambient ‘A’ or chilled ‘C’ temperatures. The apples may be stored in a compartment 12 at either temperature category without issues. Finally, the milk carton is associated with a desired chilled category, and a resilience only to chilled temperatures.

It will be appreciated that according to some embodiments of the invention, the list of items 910 is not required. It is sufficient for the order information to comprise DTI 930 indicating one or more desired temperature categories associated with the order, quantity information 920 indicating a volume requirement at each desired temperature category and TTI 940 indicative of the thermal resilience of the order. For example, for the order associated with FIG. 9B the order information 900 may comprise DTI 930 indicating that frozen, ambient and chilled space is desired and quantity information 920 indicating how much of each space is desired, e.g. one small storage space. The order information 900 may further comprise TTI 940 indicating that the ambient item(s) are resilient to chilled temperatures, and thus the order is resilient to being stored in only chilled and frozen space.

Furthermore, the DTI 930 and TTI 940 may not directly indicate temperature categories. The DTI 930 and TTI 940 may instead define specific temperatures or ranges of temperatures for storage of the items. Whilst the method 800 is described in relation to ambient, chilled and frozen temperature categories, it will be appreciated that the method may be extended to any arbitrarily defined temperatures or temperature ranges.

Returning to FIG. 8, the method 800 comprises a step 830 of identifying a capacity of the storage installation 1 for receipt of the order. The capacity is identified in dependence on the received SCTI and the DTI 930.

Step 830 comprises identifying a capacity of the storage compartments 12 of the installation 1 corresponding to the DTI 930 of the order. By capacity, it is meant an amount of available storage space in the storage installation 1 at each desired temperature indicated in the DTI 930. The amount of available storage space may be identified as a number of available compartments 12. Optionally, the amount of available storage space may be further identified as a size of the available compartments 12.

For example, if the DTI 930 indicates that the order comprises items requiring chilled and ambient compartments, step 830 may comprise identifying the number and optionally size of vacant chilled and ambient compartments 12.

If the order information 900 comprises an indication of the arrival time of the order, step 830 may comprise identifying a capacity of the storage installation at the estimated arrival time. This will allow account to be taken of compartments 12 which are presently occupied but scheduled to be vacant by the arrival time of the order. Furthermore, step 830 may comprise identifying storage compartments 12 that may be temperature controlled to reach the desired temperature by the arrival time, even though the compartments 12 may currently be configured at a different temperature. For example, if the DTI 930 indicates that an order due for arrival in four hours comprises items requiring frozen compartments, the central control system 101 may identify a number and/or size of frozen compartments 12 due to be vacant in four hours. Additionally, the central control system 101 may identify a number and/or size of vacant chilled or ambient compartments that may be sufficiently cooled to be frozen in four hours. Whether the compartment 12 can be sufficiently cooled in time may depend on the current temperature of the compartment 12, the local atmospheric temperature at the storage installation 1, and the size of the compartment 12. For example, a chilled compartment 12 may be more quickly cooled to a frozen temperature than an ambient compartment 12. Furthermore, smaller compartments 12 may be more rapidly cooled or heated than large compartments 12.

The method 800 comprises a step 840 of determining a subset of the plurality of lockable storage compartments 12 for storage of the order. The subset is identified in dependence on the identified capacity, the DTI 930 and the TTI 940.

According to an embodiment, step 840 comprises preferentially allocating the one or more items to a compartment 12 corresponding to the DTI 930. By “preferentially”, it is meant that items may be allocated to a compartment corresponding to the DTI 930 by default. That is, a subset of lockable storage compartments 12 is determined with capacity to store the order at the desired temperature(s). If such a default subset cannot be identified, or if the identified default subset does not meet a predefined condition, the subset may be adjusted, or an alternative subset may be determined. The alternative subset may be determined by accounting for the alternative storage temperatures identified in the TTI 940.

For example, in the order illustrated in FIG. 9B, step 840 may comprise allocating the items according to the DTI 930 to a frozen, an ambient or a chilled compartment. If for example there is no available ambient compartment as identified in step 830, step 840 may comprise alternatively allocating the items to a subset of compartments 12 according to the temperature tolerance. In this case, the order may instead be allocated to a frozen and a chilled compartment, negating the need to use an ambient compartment. In addition to when identifying a subset of compartments 12 according to the DTI 930 is not possible, this alternative allocation may also be implemented in order to meet one or more storage criteria, such as to reduce unused space, or improve energy efficiency as will be explained.

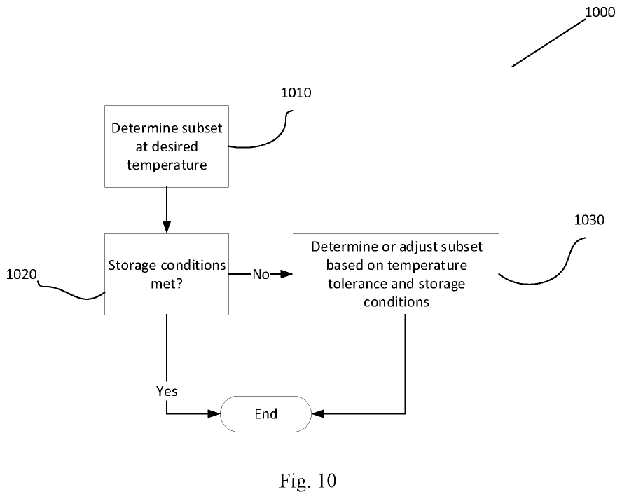

A method 1000 for determining the subset in step 830 according to an embodiment of the invention is illustrated in FIG. 10.

The method 1000 comprises a step 1010 of determining a subset of the available storage compartments 12 corresponding to the DTI 930. The subset of storage compartments 12 is determined to store each item of the order at the desired temperature, as indicated by the DTI 930. For example, if the order comprises chilled and ambient goods, in step 1010 a chilled and an ambient locker of sufficient capacity may be identified. The subset may be determined further in dependence on the quantity 920 of the order. The quantity 920 may be used to determine how many storage compartments 12 and/or what size of storage compartment 12 is required at each desired temperature. For example, if the order comprises a large quantity of frozen goods, a plurality of frozen compartments 12 or a large frozen compartment 12 may be required.

The method 1000 comprises a step 1020 for determining whether one or more predetermined storage conditions are met by the subset. If the conditions are met, the subset determined in step 1010 may be used, and the items of the order may all be stored at the desired temperatures indicated by the DTI 930. If one or more of the conditions are not met, the method 1000 may comprise a step 1030 of determining an alternative subset for storage of the items. Such an alternative subset may be determined based on the temperature tolerance TTI 940 for one or more items in the order, enabling them to be stored at an alternative temperature.

The predetermined storage conditions may comprise a space requirement for the order. The space requirement may be indicative of whether the subset comprises sufficient space to store the items. The space requirement may be defined as a minimum number of storage compartments 12 at each desired temperature for the order. The space requirement may optionally define a minimum size for one or more of the compartments 12. The minimum number and/or size of the compartments 12 may be defined in dependence on the quantity information 920 for the order.

For example, if the order comprises chilled goods and no chilled compartments 12 are identified as having capacity in step 830, then the predetermined condition may be deemed not met in step 1020 and an alternative storage solution may be sought, as will be explained. If an insufficient number or size of chilled compartments 12 are identified compared to the quantity 920 of goods, then the predetermined condition may be deemed not met in step 1020.

The space requirements may comprise an unused capacity threshold for the storage compartments 12. The unused capacity threshold is indicative of a level of unused capacity in each storage compartment 12. The unused capacity may be considered as an amount of wasted space in the allocated subset. The unused capacity may be quantified as a volume of unused space, for example in units of compartments, proportion of total space, number of items or volumetric measurements. For example, if a subset comprising one frozen compartment and one chilled compartment are allocated in step 1010 and the items of the order would only fill each compartment to 50% capacity, then the unused capacity may be quantified as 50%, or one regular sized compartment of unused capacity.

Step 1020 may comprise determining whether such an unused capacity is above a threshold. The threshold may be defined as a proportional volume, such as 50% of the subset. The threshold may be defined as an absolute volume, such as 1 compartment or 1 square meter. The unused capacity threshold may alternatively define a number of items in each compartment 12. For example, if fewer than three items are allocated to a single compartment 12, then the unused capacity may be determined to be above the threshold.

The predetermined storage conditions may comprise an energy usage threshold. The energy usage threshold is indicative of the energy usage associated with running the storage apparatus. Step 1020 may comprise determining whether use of the allocated subset will cause energy usage of the storage apparatus to exceed the energy use threshold. The energy usage will vary depending on the temperature and size of each compartment 12. For example, larger compartments consume more energy to maintain at chilled or frozen temperature than smaller compartments. Frozen compartments consume more energy than chilled or ambient compartments. Furthermore, adjusting the temperature of a compartment 12 may be more energy intensive than maintaining the temperature. Some of the compartments 12 in the determined subset may not currently be at the desired temperature category, and thus would require controlling to adjust the temperature before the arrival time of the order. Determination of the energy usage in step 1020 may therefore account for the energy required to adjust the compartment temperatures.

If one or more of the predetermined storage conditions are not met, the method may comprise a step 1030 of determining an alternative subset. Step 1030 may comprise allocating one or more of the items of the order to an alternate storage compartment corresponding to the TTI 940 in order to meet the predetermined storage conditions.

In this way, “temperature tolerant” items resilient to storage at alternative temperatures may be reallocated in order to meet the predetermined storage conditions.

Although step 1020 has been described in relation to absolute thresholds, the predetermined storage conditions may comprise improving one or more parameters relative to the subset determined in step 1010. For example, the predetermined storage conditions may comprise reducing, or optionally minimising, the unused capacity. The predetermined storage conditions comprise reducing, or optionally minimising, the number of storage compartments in the subset. The predetermined storage conditions may comprise reducing, or optionally minimising, the energy usage.

For example, for the order illustrated in FIG. 9B, step 1010 may comprise initially determining a subset comprising one frozen, one ambient and one chilled compartment, as defined by the DTI 930. However, the TTI 940 indicates the apple is a temperature tolerant item resilient to storage in chilled conditions. If the apple is alternatively stored in a chilled compartment. the number of compartments and amount of unused capacity in the subset may both be reduced, as the need for a separate ambient compartment is negated. Thus, step 1030 may comprise reallocating the apple to the chilled compartment, thus determining an adjusted subset of one chilled and one frozen compartment.

The method 800 may optionally comprise a step of controlling the temperature of one or more of the storage compartments in the subset, prior to arrival of the order. As discussed, one or more of the compartments 12 may be allocated to store items at a first temperature category, for example frozen. However, the one or more compartments 12 may not currently be configured at the first temperature category. The method 800 may then comprise controlling the temperature of the one or more compartments to attain the first temperature category in anticipation of arrival of the order.

The method 800 comprises a step 850 of unlocking the determined subset of compartments 12 responsive to arrival of the order. Step 850 may be performed as previously described. For example, the access control system 100 may be coupled to a controller 103 located in the storage installation 1 which can control the lock status of each storage space 2, as shown in FIG. 4. The delivery driver delivering the order to the storage installation 1 may be guided to the subset by any means described, such as the Delivery Driver App described with reference to FIG. 6.

As will be appreciated, the present invention provides a method for improving the efficiency of compartment allocation to incoming orders. The method provides a means for monitoring the efficiency of allocations and adjusting allocations to improve storage criteria by flexibly assigning temperature tolerant items to alternative locker categories. Thus, the capacity of the storage installation 1 is increased such that more orders may be concurrently stored.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A computer-implemented method of controlling a storage apparatus having a plurality of lockable storage compartments, wherein at least some of the storage compartments are temperature controlled, the method comprising:
obtaining storage compartment temperature information, SCTI, indicative of a locker temperature category of each storage compartment;
receiving order information associated with an order of a plurality of items for storage in the storage apparatus, wherein the order information comprises desired temperature information, DTI, associated with one or more of the items, and temperature tolerance information, TTI, associated with the one or more items, the TTI being indicative of a thermal resilience of the one or more items;
identifying, in dependence on the SCTI and the DTI, a capacity of the plurality of lockable storage compartments for receipt of the order corresponding to the DTI for the associated items;
determining a subset of the plurality of lockable storage compartments for storage of the plurality of items in dependence on the identified capacity, the DTI and the TTI; and
unlocking the subset of lockable storage compartments responsive to arrival of the order.

2. The method of claim 1, wherein the DTI is indicative of a desired locker temperature category for storage of the one or more of the items.

3. The method of claim 1, wherein the TTI is indicative of one or more further locker temperature categories to which the item is resilient.

4. The method of claim 1, wherein determining the subset comprises preferentially allocating the one or more items to a storage compartment corresponding to the DTI.

5. The method of claim 1, wherein the subset is determined further in dependence on one or more predetermined storage conditions.

6. The method of claim 5, comprising allocating at least one of the items to a storage compartment corresponding to the TTI to meet the one or more predetermined storage conditions.

7. The method of claim 5, wherein the predetermined storage conditions comprise a maximum capacity threshold at each locker temperature category.

8. The method of claim 5, wherein the predetermined storage conditions comprise an unused capacity threshold indicative of a level of unused capacity in each storage compartment, optionally wherein the predetermined storage conditions comprise minimising the unused capacity.

9. The method of claim 5, wherein the predetermined storage conditions comprise a compartment number threshold indicative of a number of storage compartments in the subset, optionally wherein the predetermined storage conditions comprise minimising the number of storage compartments in the subset.

10. The method of claim 5, wherein the predetermined storage conditions comprise an energy usage threshold indicative of the energy usage associated with the storage apparatus, optionally wherein the predetermined storage conditions comprise minimising the energy usage.

11. The method of claim 1, further comprising controlling the temperature of one or more of the storage compartments in dependence on the order information.

12. The method of claim 1, wherein the order information comprises an estimated arrival time for the order, and wherein the subset is determined further in dependence on the arrival time.

13. The method of claim 1, wherein the locker temperature category is indicative of a chilled, frozen or ambient temperature range.

14. The method of claim 13, wherein a chilled temperature category is indicative of a temperature between substantially 0 degrees Celsius and substantially 4 degrees Celsius, a frozen temperature is indicative of a temperature between substantially −25 degrees Celsius and substantially 0 degrees Celsius, and an ambient temperature category is indicative of a temperature between substantially 4 degrees Celsius and substantially 21 degrees Celsius.

15. A controller for a storage apparatus having a plurality of lockable storage compartments wherein at least some of the storage compartments are temperature controlled, the controller being arranged to:
obtain storage compartment temperature information, SCTI, indicative of a locker temperature category of each storage compartment;
receive order information associated with an order of a plurality of items for storage in the storage apparatus, wherein the order information comprises desired temperature information, DTI, associated with one or more of the items, and temperature tolerance information, TTI, associated with the one or more items, the TTI being indicative of a thermal resilience of the one or more items;
identify, in dependence on the SCTI and the DTI, a capacity of the plurality of lockable storage compartments for receipt of the order corresponding to the DTI for the associated items;
determine a subset of the plurality of lockable storage compartments for storage of the plurality of items in dependence on the identified capacity, the DTI and the TTI; and
output a signal to unlock the subset of lockable storage compartments responsive to arrival of the order.

16. A storage apparatus having a plurality of lockable storage compartments wherein at least some of the storage compartments are temperature controlled, the storage apparatus comprising a controller according to claim 15.

17. A computer readable medium storing software which, when executed, is arranged to perform a method according to claim 1.
